(19) United States
(12) Patent Application Publication
(10) Pub. No.: US 2010/0052620 A1
(43) Pub. Date: Mar. 4, 2010

(54) BATTERY CHARGER IC INCLUDING BUILT-IN USB DETECTION

(75) Inventor: CHUCK WONG, Union City, CA (US)

Correspondence Address: HOWISON & ARNOTT, L.L.P, P.O. BOX 741715, DALLAS, TX, 75374-1715, US

(73) Assignee: INTERSIL AMERICAS INC., Milpitas, CA (US)

(21) Appl. No.: 12/423,056

(22) Filed: Apr. 14, 2009

Related U.S. Application Data
(60) Provisional application No. 61/093,966, filed on Sep. 3, 2008.

(51) Int. Cl. H02J 7/00

(52) U.S. Cl. 320/137

(57) ABSTRACT

A charging circuit included on a single integrated circuit including first circuitry for generating a charging current responsive to an input voltage source. The input voltage source may comprise a USB voltage source or a non-USB voltage source. A USB detection circuit determines whether the input voltage source comprises the USB voltage source or the non-USB voltage source.

### CROSS REFERENCE TO RELATED APPLICATION

This application claims the benefit of U.S. Provisional Application No. 61/093,966, filed Sep. 3, 2008, and entitled CHARGER IC WITH BUILT-IN USB DETECTION, the specification of which is incorporated herein by reference in its entirety.

### BRIEF DESCRIPTION OF THE DRAWINGS

For a more complete understanding, reference is now made to the following description taken in conjunction with the accompanying Drawings in which:

FIG. 1 is a block diagram of a prior art USB detection system;

FIG. 2 is a top-level block diagram of a USB charger circuit including built-in USB detection capabilities;

FIG. 3 is a schematic diagram of a USB detection circuit;

FIG. 4 is a table illustrating the operation of the USB detection circuit of FIG. 3;

FIG. 5 is a block diagram of a charging IC including integrated USB detection capabilities; and

FIG. 6 is a flow diagram describing the manner in which the USB detection circuit of FIG. 3 operates.

### DETAILED DESCRIPTION

Referring now to the drawings, wherein like reference numbers are used herein to designate like elements throughout, the various views and embodiments of a battery charger IC including built-in USB detection are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Universal Serial Bus (USB) technology has been expended beyond its main interface function purpose of providing data communications between connected devices. In 2006, China standardized cell phone charger connectivity to be of the miniUSB type in order to avoid large volume recycle of the power adapters when the handsets were recycled. Under this standard, a wall adapter must also use the miniUSB connector, where the D+ and D− pins of the USB connection need to be connected to each other and floating from anything else. All mobile phones are required to be designed to use the miniUSB receptacle as the power input, whether the device has USB function or not. A USB port within a portable electronic device is now commonly used to provide a 5V source for a non-USB device. Thus, the USB port may be used for driving an LED lamp, a fan, charging a battery, and other similar-type applications. A major application in this area is to use the USB port to charge handheld electronic devices, such as mobile phones, PDAs, MP3 players, digital cameras, etc.

Most of those handheld electronic devices have been designed to enable the battery to be charged with the USB port. To use the USB port power as a source to charge the battery, some strict USB specification guidelines must be met. One major restriction is that the maximum current that can be drawn from a USB source is limited to 500 mA for high power port and 100 mA for low power port. A low power port is a port that gets power from an upstream USB port.

Portable electronic devices can be charged through the USB port by using a non-USB power adapter. Due to the difference in current limit settings between a USB port and a non-USB power adapter, the electronic device must be capable of detecting the input source type and setting the charging current accordingly for the battery of the electronic device. When the battery of a handheld electronic device is charged with a USB power source, the handheld device must identify the USB source and set the charge current to meet the current level established by the USB specification limit. The identification can be accomplished by the USB transceiver if the handheld electronic device includes a USB function, or alternatively, it may be accomplished by a dedicated USB detection IC.

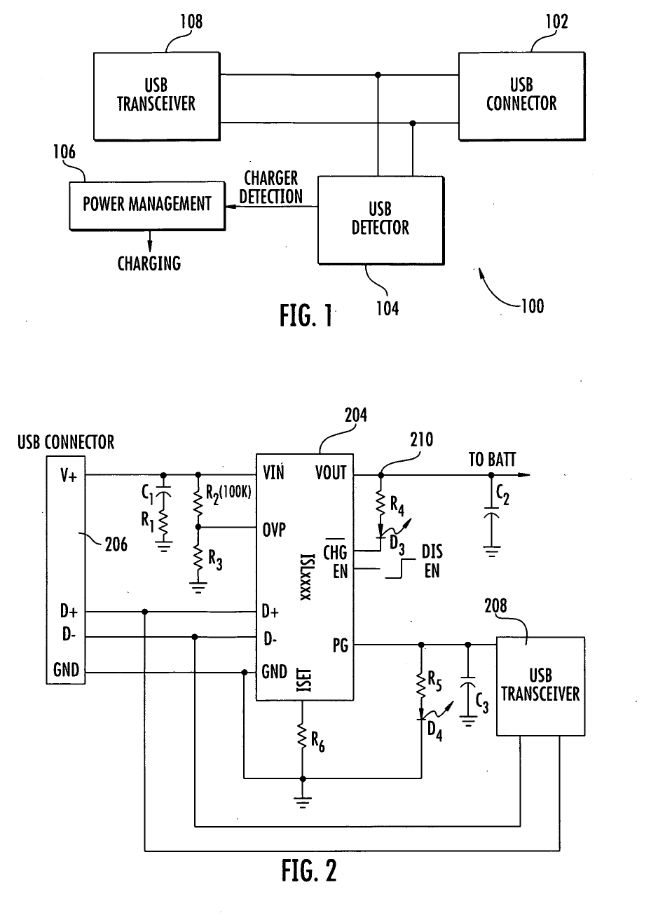

One example of a dedicated detection IC is more fully illustrated in FIG. 1. FIG. 1 is a block diagram illustrating charging circuitry, including a separated USB detection circuitry 104. In this embodiment, a USB connector 102 associated with the portable electronic device 100 is connected with a separate USB detector chip 104 connected between the USB connector 102 and the power management circuitry 106 of the portable electronic device 100. The USB detector 104 comprises a separate integrated circuit chip within the portable electronic device 100 that monitors the communications over the USB connector 102 and generates a USB detection signal to the power management circuitry 106, which controls the charging control signals within the portable electronic device 100.

USB communications are carried out over the USB connector 102 via a USB transceiver circuit 108 within the portable electronic device 100. By monitoring these communications to the USB transceiver 100, the USB detector circuit 104 may determine whether a USB device has been connected for charging purposes. The USB detector 104 identifies a USB source connected via the USB connector and generates an indication to the power management circuitry 106 when a device is being connected for charging purposes. The power management circuitry 106 provides the charging signals necessary for establishing the charging current associated with the device being charged over the USB connector 102.

In an alternative method described herein below, rather than utilizing a separate USB detector chip 104 to determine whether the USB connector is connected with a USB charging source or a wall adapter charging source, the USB detection capability may be integrated within the battery charging circuitry of the portable electronic device. This configuration eliminates the need of an extra IC within the portable electronic device and the necessity for any interface between the USB detector IC 104, the USB connection 102 and power management circuitry 106.

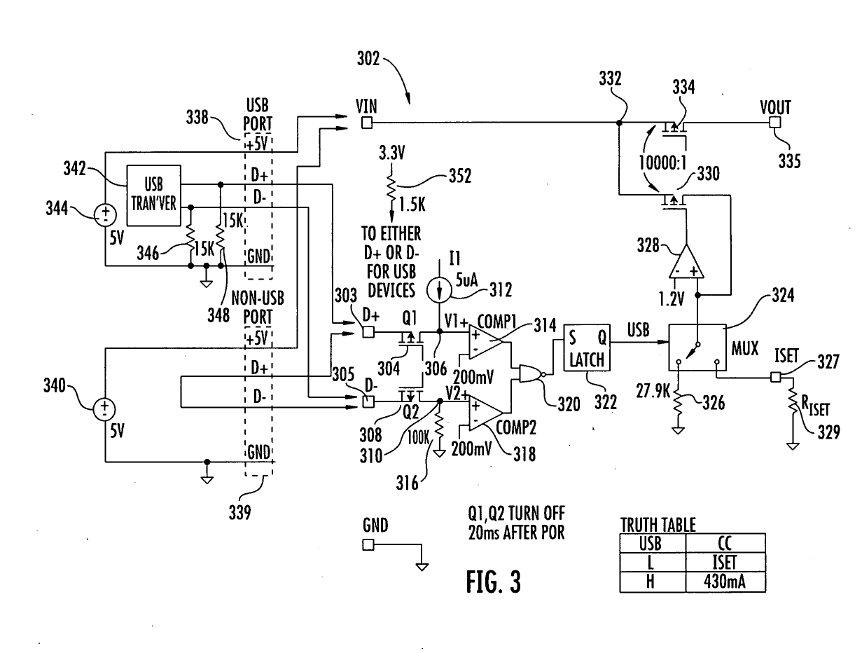

Referring now to FIG. 2, there is illustrated a USB charging circuit including built-in USB detections capability. The charging circuit 204 with built-in USB detection capability provides USB detection such that the charging circuit can be self-contained without requiring supervision from a host controller or separate USB Source detection IC, such as that described with respect to FIG. 1. The USB charger 204 including built-in detection circuitry is integrated upon a single chip. The circuit integrates detection capabilities within the charging IC and provides reliable USB detection without interfering with USB high-speed communications. In this implementation, the USB charger circuit 204 including the built-in USB detection is connected to the USB connector 206 at the V+ pins, D+ and D− pins and ground pins, respectively. The USB connection 206 is connected from V+ output to the VIN input of the USB charger circuit 204. USB communications are monitored by connections between D+ and D− pins of the USB connector 206 and the USB charger circuit 204. Also connected to the D+ and D− pins of the USB connector 206 is USB transceiver circuitry 208 for performing USB communications. The detection circuit is shown in FIG. 3. A 5V voltage source 340 connects between the ground pin and the +5V pin of the non-USB port 339. Another 5V voltage source 344 connects between the +5V pin and the ground pin of the USB port 338. USB transceiver circuitry 342 connects with the detection circuitry 302 at the D+ and D− pins of the USB port 338. Pull-down resistors 346 and 348 are connected between the D− and D+ pins, respectively, and ground.

The battery charger circuitry provides an output charging voltage via the VOUT pin connected to the associated battery being charged of the portable electronic device at node 210. USB charger circuit 204 comprises a typical application circuit interfacing with a four-pin USB connector 206 that is part of the handheld electronic device. Through the USB connector 206, the USB charger 204 may identify the source type connected to the USB connector 206 using USB detection circuitry as described more fully hereinbelow.

FIG. 3 more particularly illustrates a schematic diagram of the USB detection circuit 302 for identifying a voltage source type connected with the USB port 338. The USB detection circuitry 302 includes an input voltage node 332, wherein the input voltage VIN is provided. The V_{IN} node 332 is connected to the +5V pin of the USB port 338 and with a +5V pin of a non-USB port 339. A D+ input node 303 of the detection circuitry 302 is connected with D+ pins of the USB port 338 or the non-USB port 339. A D− input node 305 is connected to the D− pins of the USB port 338 or the non-USB port 339. A transistor 304 is connected with the D+ node 303. The source-drain path of the transistor 304 is connected between node 303 and node 306. A second transistor 308 has its source-drain path connected between node 305 and node 310. Sourced into node 306 is a 5 μA current source 312. Node 306 is connected to a non-inverting input of a comparator 314. The inverting input of the comparator 314 is connected to a 200 mV reference voltage.

A resistor 316 is connected between node 310 and ground. Node 310 is also connected to the non-inverting input of a comparator 318. The inverting input of the comparator 318 is connected to the 200 mV reference voltage. The output of comparator 314 and the output of comparator 318 are connected to the inputs of a NAND gate 320. The output of NAND gate 320 is connected to the S (SET) input of a latch circuit 322. The output of the latch circuit 322 provides a control signal from its Q output to a multiplexer 324. The output of the latch 322 acts as a control input to the multiplexer 324 as will be described more fully hereinbelow. The latch circuit 322 is powered by the IC's input power. If the source is removed, the latch will be reset. Otherwise the latch will retain the input source indicating either a TA or USB source connection.

One input of the multiplexer 324 is connected to a resistor 326 that is connected to ground. The second input of the multiplexer 324 is connected to the ISET pin 327 of the charger IC, which is connected to ground through an external resistor RISET 329. The output of the multiplexer 324 is connected to the non-inverting input of amplifier 328. The inverting input of amplifier 328 is connected to a 1.2V reference voltage. The output of the amplifier 328 is connected to the gate of a transistor 330. The drain-source path of transistor 330 is connected between non-inverting input of the comparator 328 and node 322. A transistor 334 is connected between the input voltage node 332 and the output voltage node VOUT 335.

When the non-USB port 339, or a travel adapter (TA) connected to a wall plug with USB connection is used to supply power to the charger via the USB port 338, the D+ and D− pins must be connected together and floating from anything else. Additionally, the USB port D+ and D− pins are connected to ground through 15K resistors 346 and 348. A third requirement is that the USB device must include a 1.5K pull-up resistor 352 at either the D+ or D− pins of the connected device as a system speed identifier. The pull-up is placed on the D− pin if the system speed is a low-speed type USB connection and on the D+ pin if the device is a full, or high-speed, type USB connection.

The USB detection circuitry 302 provides connections to the D+ and D− pin interface of the USB connector 338 or the non-USB connector 339 to achieve the USB detection functionality. The internal 5 μA source current 312 is injected into the D+ pin between the transistor 304 and the non-inverting input of comparator 314. The voltage comparators 314 and 318 associated with each of the D+ node 303 and the D− node 305 compare the voltages on each of the D+ and D− pins with a 200 mV reference voltage. The portable device including the charging circuitry and the USB detection circuitry 302 can detect a USB device connection or a non-USB device connection, i.e., it uses the USB connector solely for supplying power to the charger. Thus, depending on the input source type and the type of device, the output of comparator 314 and 318 will determine whether the input source is a USB source or a TA (travel adapter) source.

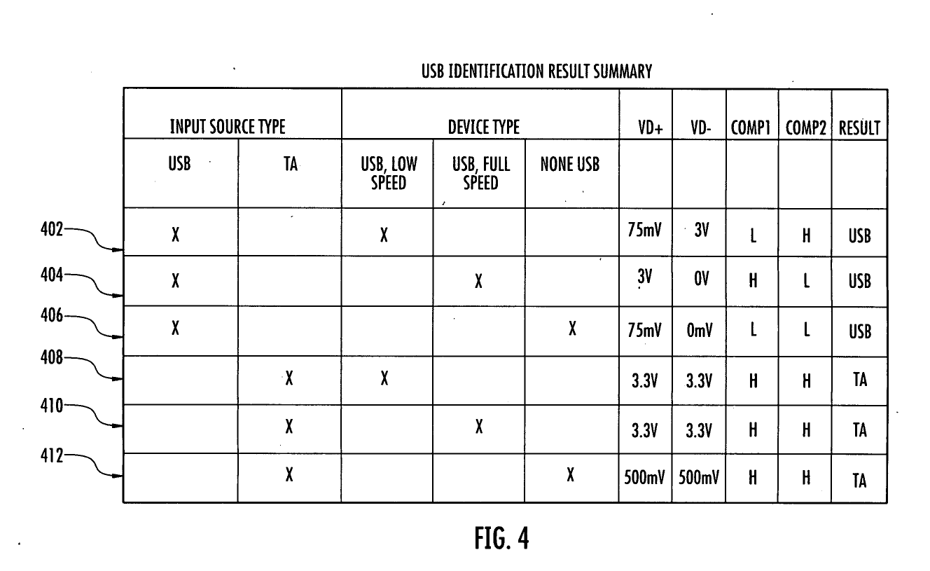

The outputs of the comparator 314 and the comparator 318 and the associated pin voltages and device types associated with these comparator and voltage values are more fully illustrated in FIG. 4. If a USB source connector 338 is plugged in to the receptacle of the detection circuit 302, and the plugged-in device includes a low speed USB function, the D− pin voltage at node 305 will be approximately 3V. The indication that the device has a low speed USB function would be indicated by the D− pin of the associated device being pulled up to 3.3V through a 1.5K resistor 352 on the device side. The D+ node 303 voltage will comprise 75 mV (5 μA×15K). As can be seen in row 402, this will drive the output status of comparator 314 to a logical “low” level, and the output status of comparator 318 to a logical “high” level. This will ultimately drive the output of the NAND gate 320 connected with comparators 314 and 318 to a logical “high” level, indicating that a USB input source is connected.

Similarly, as indicated generally in row 404 of FIG. 4, if a USB source connector 338 is plugged in to the receptacle of the detection circuit and the plugged-in device has a full or high speed USB functionality as indicated by the D+ pin being pulled up to 3.3V through a 1.5K resistor 352, the D+ pin will be at 3V and the D− node 305 will be at 0V or ground. Under these conditions, the output state of comparator 314 is at a logical “high” and the output state of comparator 318 is at a logical “low” state. This also provides a logical “high” output from the NAND gate 320, providing an indication that a USB source is connected. Finally, as generally indicated in row 406, if a USB source connector 338 is plugged in to receptacle of the detection circuit 302 and the device has no USB functionality, the voltage at the D+ node 303 equals to 75 mV (5 μA×15K) and the voltage at D− node 305 will be at 0V or ground. The resulting output status of comparator 314 would go to a logical “low” level and the output status of the comparator 318 would also go to a logical “low” level. This would cause the output of the NAND gate 320 to also go to a logical “high” level, providing an indication that a USB device was connected.

If a TA is plugged in through the USB connector 339, as indicated in row 408, and the device has a low speed USB functionality, as indicated by the D− pin being pulled up to 3.3V through the 1.5K resistor 352, the D− pin voltage will be approximately 3.3V. The D+ pin voltage is also 3.3V, since D+ and D− are tied together. The outputs of comparator 314 and 318 will each go to a logical “high” level and the output of NAND gate 320 will be a logical “low” level, indicating that the input source type is a TA. Similarly, if a TA is plugged in through the USB connector 339, as indicated in row 410, and the device has a full speed or high speed USB function, the outputs of each of comparators 314 and 318 will be at a logical “high” level driving the output of NAND gate 320 to a logical “low” level. This provides an indication of a TA source. Finally, if a TA is plugged in through the USB connector 339 and the device has no USB functionality, the voltage the D+ and D− pins is 500 mV (5 μA×100 k), and the outputs of the comparators 314 and 318 will be at a logical “high” level, and the NAND gate 320 will all be at logical “low” level, providing an indication that the TA device is connected.

Thus, the output status of the comparators 314 and 318 can be used to differentiate between the input source types based upon the output of NAND gate 320. The NAND gate 320 outputs a logical “low” level for a TA input source, and a logical “high” level for a USB input source. The identification process to determine whether a USB or TA input source is provided will be completed within 20 ms after power-on reset (POR) and the ID status from NAND gate 320 is latched in to the latch register 322 until the input source is removed. The two transistors 304 and 308 connected to the D+ and D− input nodes, respectively, will be turned off once the ID process is completed in order to isolate the identification circuit 302 from the D+ and D− nodes.

After completion of the input source identification, if the input type is identified as a travel adapter, the constant charge current will be determined by the ISET pin resistor 329. If the input is identified as a USB source, the charge current will be set to 430 mA set by the internal resistor 326. This is done by the indication from the latch 322 providing the identification control signal to the multiplexer 324 which selects between one of the resistors 326 and 329 to set the charge current to the output voltage node 335. If the input source is a travel adapter, the charge current during the constant current phase will be determined by the RISET resistor 329. If the input source is a USB source, the charge current during the constant current phase will be approximately 430 mA.

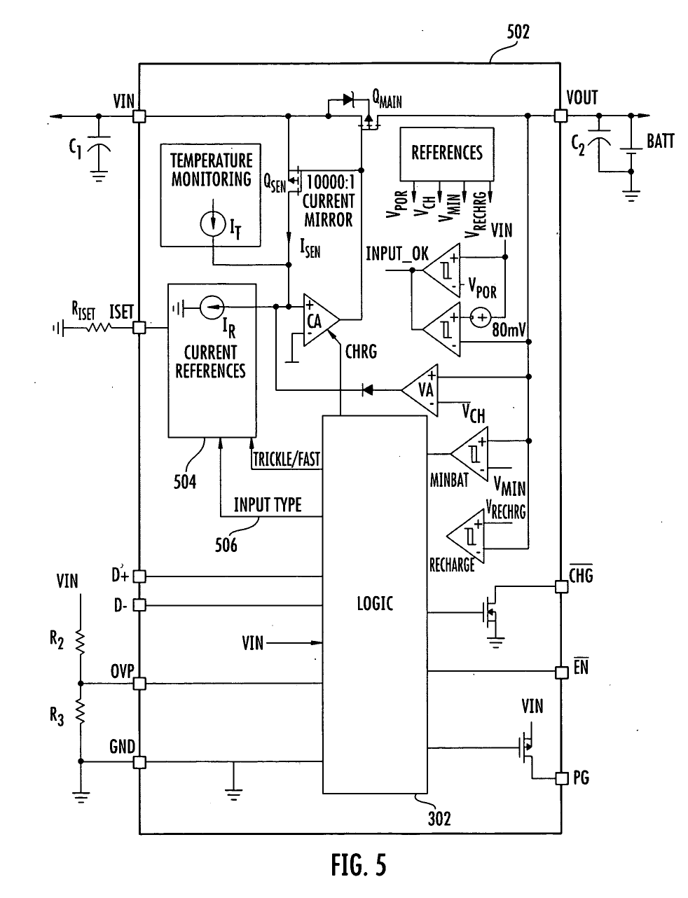

Referring now also to FIG. 5, there is illustrated an implementation of the USB detection circuitry logic 302 within a charging IC 502. The logic circuitry 302 is connected with the D+ and D− pins as described with respect to FIG. 3, and the voltage source input type is provided to the reference current circuitry 504 via an input line 506. Using the charger IC 502 with built-in USB detection 302, no separate USB transceiver or USB source detection IC circuitry is required within the portable electronic device. The circuitry provides a simple and reliable circuit within a single IC implementation.

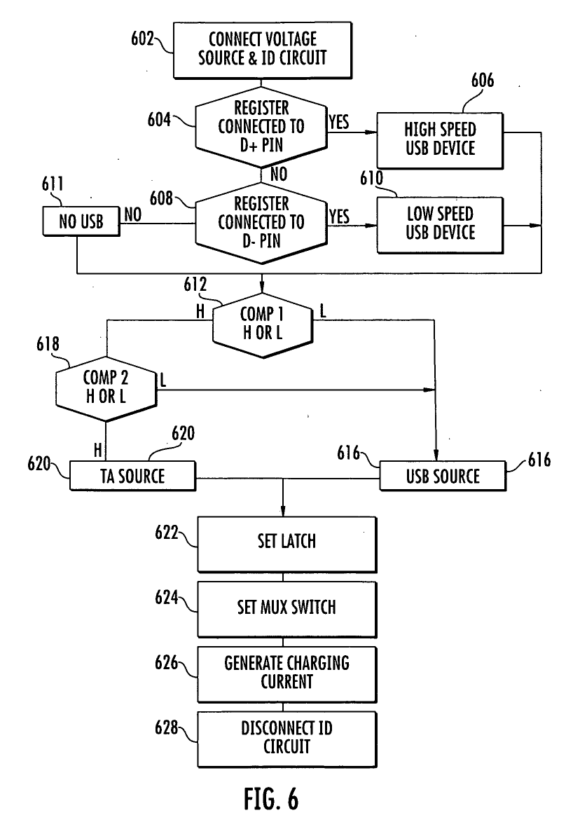

Referring to FIG. 6, there is a flow diagram describing the IC detection process. Initially, at step 602, a voltage source, either the USB port 338 or non-USB port 339 is connected at the VIN of IC 502, and D+ and D− pins on the USB connector is connected to the D+ and D− pins of the IC 502. Inquiry step 604 determines whether there the 1.5K resistor is connected to the D+ pin. If so, the connected device is established as having high speed USB capabilities at step 606. If inquiry step 614 does not determine that a resistor is connected to the D+ pin, inquiry step 608 determines whether the 1.5K resistor is connected to the D− pin. If so, the device is established as having low speed capabilities at step 610. If the device has no resistor connected to the D− pin, then the device is determined to be a non-USB device at step 611. From each of steps 606, 610 and 611, control passes to inquiry step 612, which determines if the comparator 314 has a logical “high” or “low” output. If comparator 314 has a logical “low” output, control passes to inquiry step 616 to indicate the attached device comprises a USB voltage source. If inquiry step 612 determines that comparator 314 is at a logical “high” level, then control passes to inquiry step 618, which determines whether the comparator 318 is a logical “high” or “low” level. If comparator 318 is at a logical “low”, the device is established as a USB source at step 616. If inquiry step 618 determines that comparator 318 is at a logical “high” level, the connected device is established as a travel adapter source at620.

Once the device is established as a USB source at step 616 or as a travel adapter source at step 620, this indication for the source is latched in by the latching circuit 322 at step 622. This indicator is used to set the multiplexer switch at step 624 to control the charging current provided at the output voltage node 335. The charging current is generated at step 626 by applying the current based upon the resistor selected by the multiplexer circuit 324. Once the indicator and charging current have been established, the USB identification circuit is disconnected at step 628 by turning off transistors 304 and 308 until the voltage source is removed. Removal of the voltage source causes resetting of the latch 322.

Using the above-described circuitry, a USB source detection capability may be integrated within a battery charging device without requiring a separate USB detection circuit IC, as is required in some prior art methods.

It will be appreciated by those skilled in the art having the benefit of this disclosure that this disclosure provides a battery charger IC including built-in USB detection. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A charging circuit included on a single integrated circuit, comprising:
charging circuitry for generating a charging current responsive to an input voltage source, wherein the input voltage source may comprise a USB voltage source or a non-USB voltage source; and
USB detection circuit for determining whether the input voltage source comprises the USB voltage source or the non-USB voltage source.

2. The charging circuit of claim 1, wherein the USB detection circuit is connected to D+ pin and D− pin of an interface associated with the voltage source while determining whether the input voltage source comprises the USB voltage source or the non-USB voltage source and is disconnected from the D+ pin and the D− pin of the interface with the input voltage source once the determination of the USB source or non-USB voltage source is made.

3. The charging circuit of claim 1, wherein the USB detection circuit further comprises:
first circuitry for comparing a first voltage associated with a D+ pin of an interface associated with the input voltage source and a second voltage associated with a D− pin of the interface associated with the input voltage source with a reference voltage and generating an indication whether the input voltage source is the USB voltage source or the non-USB voltage source responsive thereto; and
a latch circuit for latching the indication to a present value; and
second circuitry for generating a first charging current responsive to the indication that the input voltage source is the USB voltage source and for generating a second charging current responsive to the indication that the input voltage source is the non-USB voltage source.

4. The charging circuit of claim 3, wherein the first circuitry further comprises:
a first comparator for comparing the first voltage with the reference voltage and generating a first comparator output;
a second comparator for comparing the second voltage with the reference voltage and generating a second comparator output; and
a logic gate for generating the indication responsive to the first comparator output and the second comparator output.

5. The charging circuit of claim 3, wherein the second circuitry further comprises:
a first resistor for providing the first charging current;
a second resistor for providing the second charging current; and
a multiplexer responsive to the indication for switching between the first resistor and the second resistor.

6. The charging circuit of claim 1, further comprising:
a first switch for disconnecting the USB detection circuit from a D+ pin of an interface associated with the input voltage source once a determination is made if the input voltage source is a USB voltage source or a non-USB voltage source; and
a second switch for disconnecting the USB detection circuit from a D− pin of an interface associated with the input voltage source once a determination is made if the input voltage source is a USB voltage source or a non-USB voltage source.

7. A USB detection circuit for use with a battery charger integrated circuit, comprising:
first circuitry for comparing a first voltage associated with a D+ pin of an interface associated with an input voltage source and a second voltage associated with a D− pin of the interface associated with the input voltage source with a reference voltage and generating an indication whether the input voltage source is a USB voltage source or a non USB voltage source responsive thereto; and
a latch circuit for latching the indication to a present value; and
second circuitry for generating a first charging current responsive to the indication that the input voltage source is the USB voltage source and for generating a second charging current responsive to the indication that the input voltage source is the non USB voltage source.

8. The USB detection circuit of claim 7, wherein the first circuitry is connected to D+ pin and D− pin of the interface associated with the voltage source while determining whether the input voltage source comprises the USB voltage source or the non USB voltage source and is disconnected from the D+ pin and the D− pin of the interface with the input voltage source once the determination of the USB source or non USB source is made.

9. The USB detection circuit of claim 7, wherein the first circuitry further comprises:
a first comparator for comparing the first voltage with the reference voltage and generating a first comparator output;
a second comparator for comparing the second voltage with the reference voltage and generating a second comparator output; and
a logic gate for generating the indication responsive to the first comparator output and the second comparator output.

10. The USB detection circuit of claim 7, wherein the second circuitry further comprises:
a first resistor for providing the first charging current;
a second resistor for setting the second charging current; and
a multiplexer responsive the indication for switching between the first resistor and the second resistor.

11. The USB detection circuit of claim 7, further comprising:
a first switch for disconnecting the first circuitry from a D+ pin of an interface associated with the input voltage source once a determination is made if the input voltage source is a USB voltage source or a non-USB voltage source; and
a second switch for disconnecting the first circuitry from a D− pin of an interface associated with the input voltage source once a determination is made if the input voltage source is a USB voltage source or a non-USB voltage source.

12. A method for charging a battery of a device using either a USB voltage source or a non-USB voltage source, comprising the steps of:
determining whether an input voltage source comprises the USB voltage source or the non-USB voltage source;
providing an indication of whether the input voltage source comprises the USB voltage source or the non-USB voltage source; and
generating a charging current responsive to the input voltage source and the provided indication.

13. The method of claim 12, further comprising the steps of:
connecting to a D+ pin and a D− pin of an interface associated with the voltage source while determining whether the input voltage source comprises the USB voltage source or the non-USB voltage source; and
disconnecting from the D+ pin and the D− pin of the interface with the input voltage source once the determination of the USB voltage source or non-USB voltage source is made.

14. The method of claim 12, wherein the step of determining further comprises the step of:
comparing a first voltage associated with a D+ pin of an interface associated with the input voltage source and a second voltage associated with a D− pin of the interface associated with the input voltage source with a reference voltage; and
generating the indication of whether the input voltage source is the USB voltage source or the non-USB voltage source responsive thereto.

15. The method of claim 14, wherein the step of providing further comprises the step of latching the indication to a present value.

16. The method of claim 15, wherein the step of generating the charging current further comprises the steps of:
generating a first charging current responsive to the indication that the input voltage source is the USB voltage source; and
generating a second charging current responsive to the indication that the input voltage source is the non-USB voltage source.

17. The method of claim 14, wherein the step of generating the indication further comprises the steps of generating the indication responsive to the comparison of the first voltage and the second voltage with the reference voltage.

18. The method of claim 12, wherein the step of generating the charging current further comprises steps of selecting one of a first resistor providing a first charging current and a second resistor providing a second charging current responsive to the indication of the input voltage source.
